(19) United States
(12) Patent Application Publication
(10) Pub. No.: US 2017/0364374 A1
(43) Pub. Date: Dec. 21, 2017

(54) CONTRACT NEGOTIATION ASSISTANCE SYSTEM AND METHOD

(71) Applicant: Wal-Mart Stores, Inc., Bentonville, AR (US)

(72) Inventor: Alistair J. Maiden, Scarcroft (GB)

(21) Appl. No.: 15/628,259

(22) Filed: Jun. 20, 2017

Related U.S. Application Data
(60) Provisional application No. 62/352,476, filed on Jun. 20, 2016.

(51) Int. Cl. G06F 9/44; G06F 3/0481; G06Q 30/02; G06Q 10/10

(52) U.S. Cl. CPC G06F 9/4446; G06Q 10/101; G06Q 10/10; G06F 3/0481; G06Q 30/0281; G06F 2221/21; G06Q 2220/10; G06Q 2220/123

(57) ABSTRACT

In some embodiments, systems, apparatuses, methods, and processes are provided to assist parties in contract negotiations. In some embodiments, a system for use by a first party in contract negotiation with a second party comprises: a control circuit; and a contract term playbook database accessible by the control circuit; wherein the control circuit is configured to: receive, from a user of the first party via a user interface, feedback from the second party regarding a contract term of a draft contract; access the contract term playbook database using the feedback; and output, to the user via the user interface, guidance for response to the second party regarding the contract term and preapproved by the first party.

### CROSS-REFERENCE TO RELATED APPLICATION

This application claims the benefit of U.S. Provisional Application No. 62/352,476 filed Jun. 20, 2016, which is incorporated herein by reference in its entirety.

### TECHNICAL FIELD

This invention relates generally to contract negotiations between two parties, and more specifically relates to systems that assist parties in contract negotiations.

### BACKGROUND

Contracts are often negotiated between two parties where a first party presents a draft contract to a second party. In many cases, the second party objects to one or more contract terms and communicates concerns to the first party regarding these terms. As part of reasonable business practices, often the first party consults with legal counsel regarding proposed contract changes and comments by the second party.

### BRIEF DESCRIPTION OF THE DRAWINGS

Disclosed herein are embodiments of systems, apparatuses and methods pertaining to the assistance of a party during contract negotiation. This description includes drawings, wherein:

FIG. 1 illustrates a simplified block diagram of a system for use by a party in negotiating contracts with other parties in accordance with some embodiments.

FIG. 2 illustrates a simplified flow diagram of an exemplary process of negotiating contracts in accordance with some embodiments.

FIGS. 3-8 illustrate various simplified user interface displays presented to a user of a contracting party in accordance with some embodiments.

FIG. 9 illustrates various data stored in a database structure in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

Generally speaking, pursuant to various embodiments, systems, apparatuses and methods are provided herein useful to assist parties in contract negotiations. In some embodiments, a system for use by a first party in contract negotiation with a second party comprises: a control circuit; and a contract term playbook database accessible by the control circuit; wherein the control circuit is configured to: receive, from a user of the first party via a user interface, feedback from the second party regarding a contract term of a draft contract; access the contract term playbook database using the feedback; and output, to the user via the user interface, guidance for response to the second party regarding the contract term and preapproved by the first party.

In some embodiments, the systems and methods described herein assist parties in contracting with other parties and help ensure that consistent party approved responses and adherence to legal standards are provided. In a typical contract formation scenario, a first party (e.g., a person, company or other legal entity) may seek to enter into a contract with a second party (e.g., a person, company of other legal entity). In many cases, the first party presents a draft contract to the second party and, as is quite common, the second party often rejects or pushes back on one or more proposed terms of a contract. A prudent first party should seek legal advice regarding this push back. Such legal advice may be provided by a legal professional that is an employee of the first party or may be provided by a legal professional independent of the first party (e.g., a legal professional from a law firm). Such responsive legal advice may vary as different legal professionals may be hired by the first party, each having varying degrees of knowledge of the relevant legal and factual considerations. Often, one legal professional may be engaged to provide guidance when such guidance has already been provided for a similar issue in the past. Consultation with legal professionals may be costly and introduce delay in the contracting process. In view of this and in some circumstances, contracting persons of a first party may not always seek the proper legal guidance which may result in a contract entered that is not ideal from the view of the first party. Additionally, some first parties negotiate many similar contracts in a given time period such that it is necessary to hire legal advice from a variety of legal service providers in parallel.

In some embodiments, the systems and methods provided allow for prompt and consistent feedback to users negotiating for the first party. This feedback can include guidance and options for the user when presented with a specific pushback to a specific contract term. In some embodiments, the guidance and options are pre-approved from the legal and/or business perspective of the first party. In some embodiments, the guidance is advantageously provided consistently since it is a function of the contract term playbook database and less susceptible to variations due to input from different legal professional viewpoints. Additionally, it can be appreciated that that the speed in responsiveness of the users of the first party to the second party is increased since the traditional delay with legal consultation is avoided. From the view of the first party, contracts are entered more consistently, with less time and variation and for less legal fees. Users can more confidently enter contracts and make decisions (e.g., deciding how to respond when options are presented). Adherence to use of the contract term playbook database system helps to ensure consistent responses and communications to second parties despite different second parties and different users of the first party. Users get access to approved terms and clauses without the expense of seeking legal support. The system helps ensure consistent contract responses and makes it easy for users to follow all required legal processes when negotiating contracts on behalf of the company.

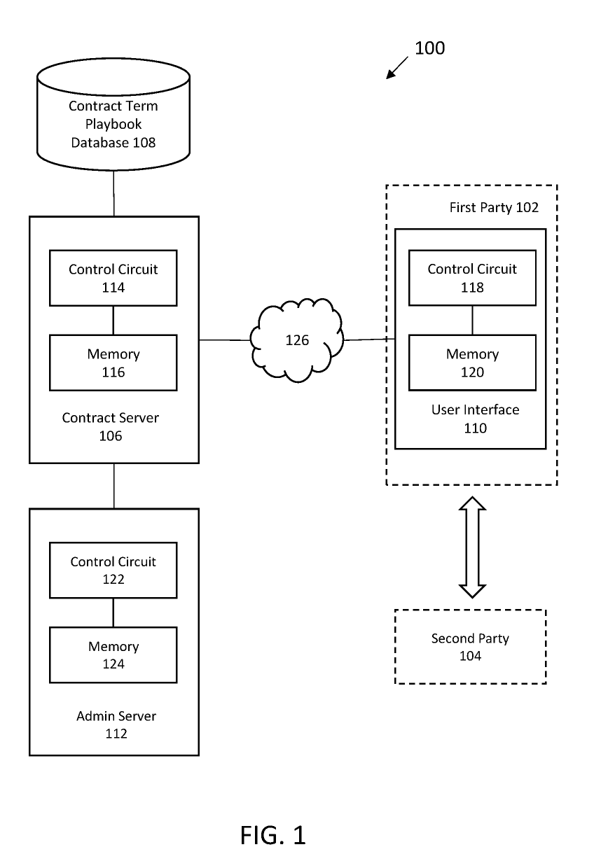

FIG. 1 illustrates a simplified block diagram of a system for use by a party in negotiating contracts with other parties in accordance with some embodiments. The system 100 illustrates a first party 102 contracting with a second party 104. Supporting a user of the first party 102 is a contract server 104 coupled to a contract term playbook database 108 and to an administrative (admin) server 112. The contract server 106 includes a control circuit 114 and a memory 116. The admin server 112 includes a control circuit 122 and a memory 124. A user interface 110 is provided for the first party 102 and is coupled to the contract server 106 via a communication network 126. The user interface 110 also includes a control circuit 118 and a memory 120.

It is noted that processes, methods, techniques, circuits, circuitry, systems, devices, functionality, services, servers, sources and the like described herein may be utilized, implemented and/or run on many different types of devices and/or systems. FIG. 1 illustrates an exemplary system 100 that may be used for implementing any of the components, circuits, circuitry, systems, functionality, apparatuses, process, or device of the system 100 of FIG. 1 and/or mentioned above or below, or parts of such circuit, circuitry, functionality, systems, apparatuses, processes, or devices. As illustrated in FIG. 1, various control circuits 114, 118 and 122 are provided. These control circuits can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. In some applications, the control circuits and/or memories may be distributed over a communications network (e.g., LAN, WAN, Internet) providing distributed and/or redundant processing and functionality. Again, the system 100 may be used to implement one or more of the above or below, or parts of, components, circuits, systems, process and the like. For example, the system may implement contract negotiation assistance to users of a first party as described herein.

As is also illustrated, each control circuit 114, 118 and 122 is coupled to a respective memory 116, 120, 124, which can be accessed by the respective control circuit, and typically includes one or more processor readable and/or computer readable media accessed by at least the control circuit/s, and can include volatile and/or nonvolatile media, such as RAM, ROM, EEPROM, flash memory and/or other memory technology. Further, the illustrated memories 116, 120, 124 are shown as internal to the respective servers 106, 112 and user interface 110; however, they can be internal, external or a combination of internal and external memory. Similarly, some or all of the memory can be internal, external or a combination of internal and external memory of the control circuits 114, 118, 122. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory. The memories can store code, software, executables, scripts, data, content, lists, programming, programs, log or history data, user information and the like.

The contract term playbook database 108 is illustrated as being coupled to the contract server 106; however, it is understood that it could also be a part of the contract server 106 or may be coupled directly or indirectly to the admin server 112 and/or the user interface 110. It is understood that the contract term playbook database can be one or more general purpose or specific purposes databases implemented on one or more computer based or memory based devices and having data stored in any known structures or formats and may be managed by one or more database management systems. The contract term playbook database may be any navigational, relational or post-relational database or other database model or structure.

It is noted that the communication network 126 couples the contract server 106 with the user interface 110. It is understood that this communication network may be any wired and/or wireless communication connectivity between such devices. For example, the communication network may include one or more communication interfaces, ports, transceivers and the like to communicate over a communication bus, a distributed computer and/or communication network (e.g., a local area network (LAN), the Internet, wide area network (WAN), etc.), communication link, other networks or communication channels with other devices and/or other such communications or combinations thereof.

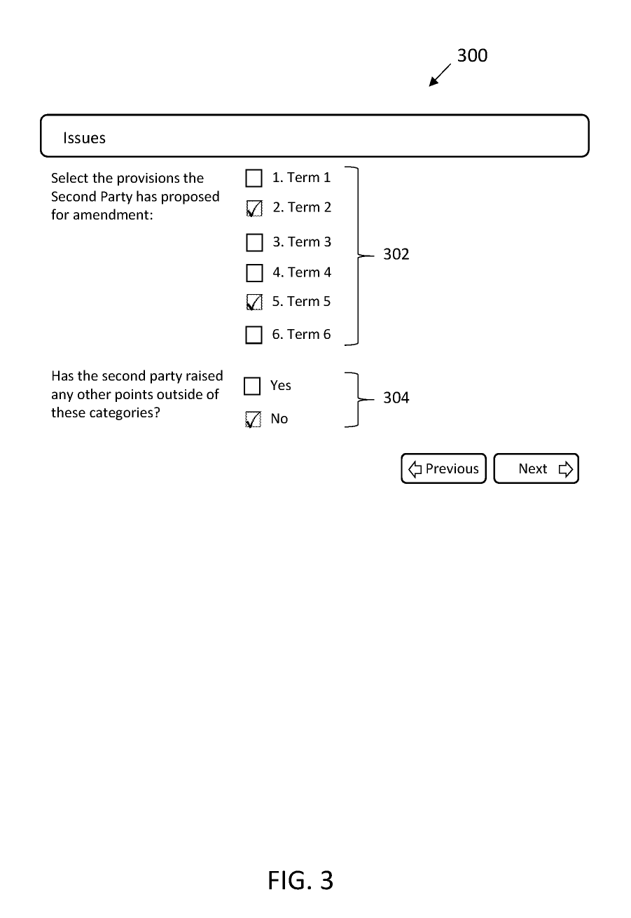

FIG. 1 also illustrates the user interface 110 used by a user of the first party 102. The user interface 110 may be any user device capable of presenting a graphical (or non-graphical) user interface or display to a user representing the first party 102. For example, the user interface 110 may be implemented on a computer device (personal computer, laptop computer, notebook computer), tablet computer, smartphone, wearable computer, and the like. Typically, the user interface 110 is capable of presenting one or more user interface displays viewable by the user to assist in contract negotiation. In some embodiments, the user interface displays are provided to the user with cooperation between the contract server 106 and the user interface 110. For example, in some embodiments, the contract server 106 serves the user interface display to the user interface 110, the user interface 110 having a browser or other software program configured to display or present the user interface display based on the instructions from the contract server 106. In other embodiments, the user interface 110 includes software or other programming to generate its own user interface display (e.g., a software program or application is installed on the user interface 110). Data to be included in the user interface display is provided by the contract server 106, but the user interface 110 generates the user interface display and provides user inputs at the user interface display to the contract server 106. By way of example, FIGS. 3-8 illustrate a series of screen shots of user interface displays presented by the user interface 110 in some embodiments. It is also understood that the user interface may be provided in visual form to be seen by the user of the first party 102 and/or may be presented in audio form to be heard by the user of the first party 102, and/or may be presented in haptic or other non-visual/non-audio format to provide information to the user of the first party 102.

Generally, as described above, and will be described in more detail below, to assist users of the first party 102 in negotiating a contract with a second party 104, a user interface 110 is provided to allow the first party to input feedback from the second party regarding one or more contract terms of a draft contract. This feedback is used by the contract server 106 which accesses the contract term playbook database 108 to automatically provide guidance for response to the second party 104, this guidance being pre-approved from one or both of the legal and business interests of the first party.

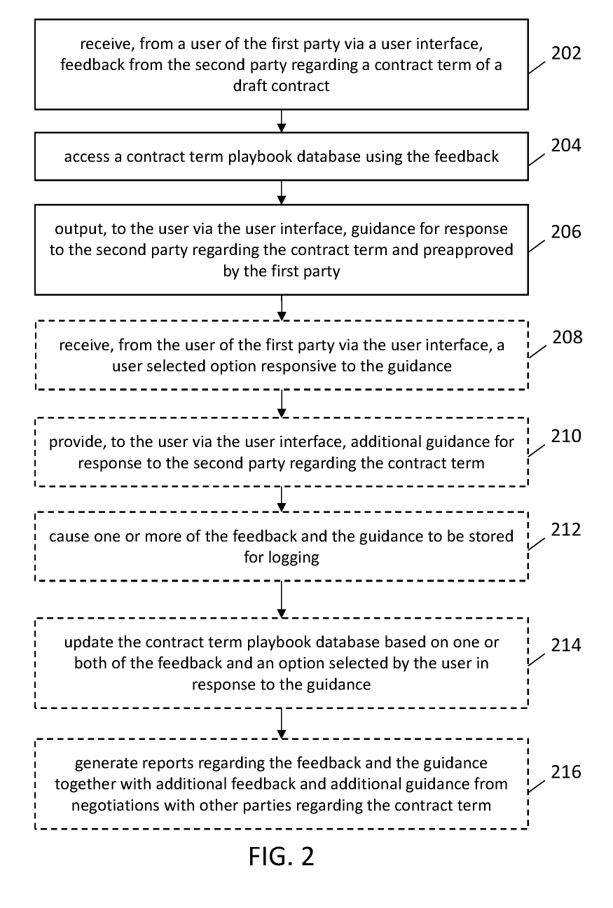

Reference will now be made to FIG. 2 which illustrates a simplified flow diagram of an exemplary process of negotiating contracts using a contract term playbook system in accordance with some embodiments. The embodiments of the method of FIG. 2 may be performed by the components of the system 100 of FIG. 1 or other systems. Additionally, while referencing FIG. 2, concurrent reference will be made to FIGS. 3-8 which illustrate various simplified user interface displays presented to a user of the first party by the control circuit 118 to the user interface 110 in accordance with some embodiments. It is understood that these user interface displays are provided by way of example and not meant to limit the embodiments of the system of FIG. 1 and/or the methods of FIG. 2.

In some embodiments, the context of the method of FIG. 2 is that a user (e.g., a business person) of a first party (a first company or other legal entity) is in the process of negotiating a contract with a representative of a second party. It is understand that one or both of the first party and the second party may also be individual persons. At a given point in the negotiation, the first party presents a draft contract or contract portion to the second party and, as is quite common, the second party provides feedback (e.g., rejects to or pushes back) on one or more proposed terms of a contract. The method starts with receiving, from a user of the first party (e.g., first party 102) via a user interface (e.g., user interface 110), feedback from the second party (e.g., the second party 104) regarding a contract term of a draft contract (Step 202). In some embodiments, the contract term comprises a position of the first party stated in the draft contract. For example, a given contract may be divided into multiple topical sections and that may be further divided into subsections. Each section and/or each subsection provides a position of the first party on that contract term topic. Each category of draft contract may have different contract provisions and terms. By way of example, contract topics or terms can be categorized to include terms such as: training, security incidents, third parties, audit, compliance, data, notice, segmentation, breach, applicability, indemnity, consideration, term, warranties, representations, etc. It will be appreciated that the number of contract terms will vary greatly on the type and purpose of contract. The second party may provide feedback to the first user on any number of these contract terms. In some embodiments, the feedback indicates less than acceptance of the contract term by the second party, e.g., the feedback can include one or more of a rejection of the contract term, a proposed alteration of the contract term, and a proposed alternative to the contract term. In some embodiments, an initial step is to input this second party feedback to the contract server.

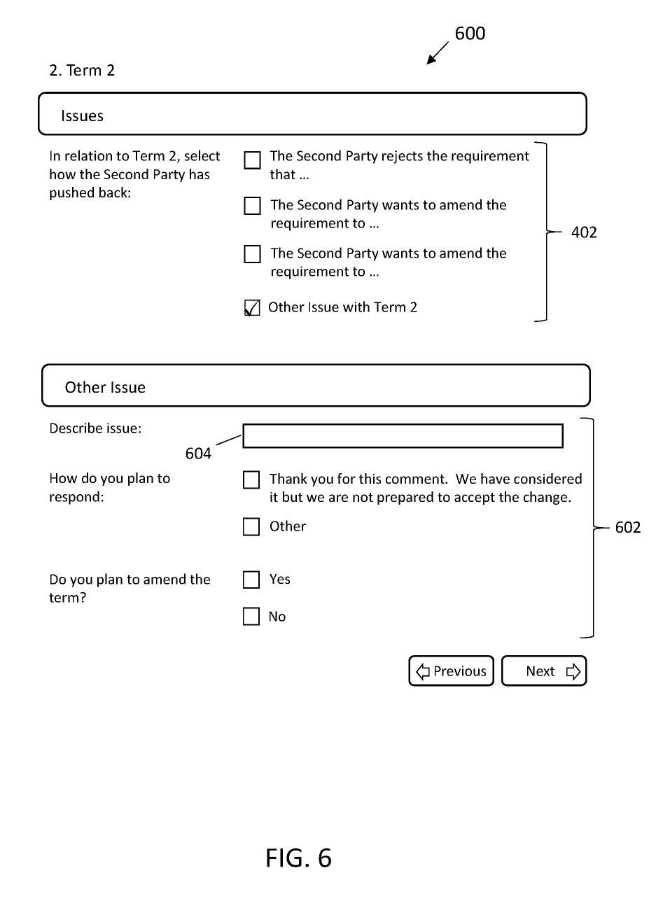

In terms of an example user interface display, the display 300 of FIG. 3 illustrates one approach to receiving the feedback from the second party. For example, the user first indicates what type of contract is being negotiated. For example, the user of the first party selected from one of a set of available contract templates, e.g., supplier agreement, information security agreement, customer order agreement. Once a contract template is selected, the user interface 110 displays the display 300 which displays a selectable list 302 the contract terms of the contract to which the second party could object. For example, the list 302 is a list of the various terms reflected in the contract. It is noted that in these drawings, the word ‘term’ is used generically, but that a heading of the term or paraphrasing of the actual term is included in a typical display. The user simply selects the terms that the second party has provided feedback. To the extent the second party's feedback is not related to a specific term, the user can so indicate in selection 304. Assuming ‘No’ is selected at 304, user display 400 is displayed to the user and this display presents a selectable list 402 all known feedback positions that are applicable to the selected contract term. For example, list 402 presents the known objections specific to selected contract term ‘2’. Should the specific feedback not be included in the list 402, the user can select ‘Other issue with Term 2’. In this event, the user of the first party can enter the specific feedback, e.g., see the other issue input section 602 of the user interface display 600 of FIG. 6. In some embodiments, the other issue input section 602 provides a free form text entry form field 604 to allow the user to explain the second party feedback or pushback. In some embodiments, the other issue input section 602 also allows the user to input a desired response and whether or not the user plans to amend the term.

Once the second party feedback has been received at the user interface, the contract term playbook database is accessed using the feedback (Step 204). For example, the feedback provided to the user interface 110 is communicated to the control circuit 114 of the contract server 106 which then accesses the contract term playbook database 108. In some embodiments, the contract term playbook database 108 stores data corresponding to one or more of: a plurality of contracts (templates), a plurality of contract terms (e.g., the relevant lists of contract terms for each contract), a plurality of possible objections by opposing contracting parties to contract terms, a plurality of response options preapproved by the first party, a plurality of responsive contract term language alterations preapproved by the first party, a plurality of complete contracts including responsive contract term language alterations preapproved by the first party, and a plurality of draft responsive communications to opposing parties preapproved by the first party. When referring to an option, guidance or response option being preapproved, the option stored in the database has already undergone business and/or legal scrutiny and is acceptable from the viewpoint of the first party with respect to a given contract term. In some embodiments, the control circuit 114 accesses the contract term playbook database to match the feedback to the guidance stored in the database 108. In some embodiments, the guidance comprises one or more of: a response option preapproved by the first party, a set of response options preapproved by the first party, a responsive contract term language alteration preapproved by the first party, a complete contract including the responsive contract term language alteration preapproved by the first party, and a draft responsive communication to the second party preapproved by the first party. Further, in some embodiments, a response option comprises one or more of: a rejection of the feedback, an acceptance of the feedback, a contract term alteration preapproved by the first party, and a proposed alternative to the contract term preapproved by the first party.

Next, the guidance for response to the second party regarding the contract term and preapproved by the first party is output to the user via the user interface (Step 206). For example, the control circuit 114 retrieves the guidance and forwards it to the user interface 110 for display to the user representing the first party. The guidance may be any of the guidance options described above and as stored in the contract term playbook database 108.

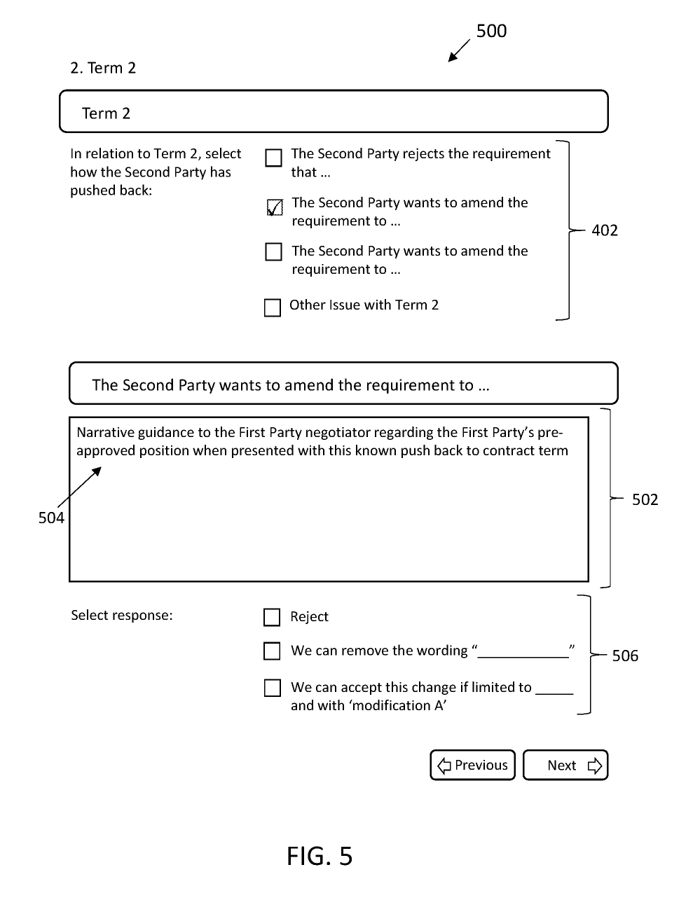

In terms of an example user interface display, the display 500 of FIG. 5 illustrates one approach to presenting the guidance to the user. For example, once the user selects the particular feedback from the list, the guidance 504 is displayed in the guidance window 502. In some embodiments, the guidance takes the form of a narrative explanation to the user describing the counter position of the first party and options for response. Depending on the feedback selected, the guidance and response options will vary, e.g., ranging from the only option being to reject the feedback to a willingness to accept certain changes in the term language or substitution of terms. To the extent a response option is selectable by the user, a selectable response option list 506 is displayed to the user. In the illustrated embodiment, the user has the choice to reject the feedback, remove certain wording and accept the feedback with other certain modifications. Again, all guidance and response options are preapproved from a legal and/or business perspective of the first party.

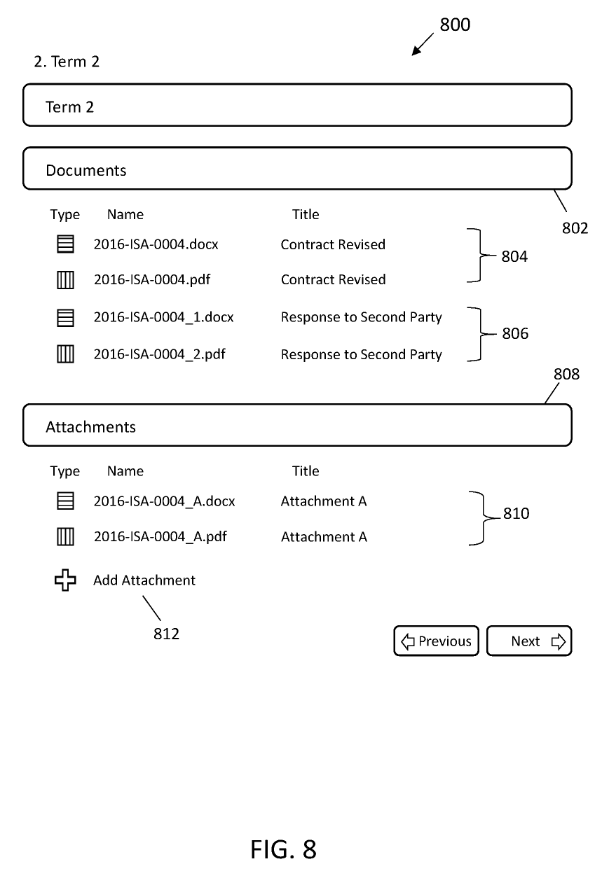

As indicated above, the guidance may include a narrative description of the overall response options available to the user and/or selectable response options. And depending on the options and guidance, the guidance may include specific modifications to contract term language and/or a replacement contract including the modifications to the contract terms that are associated with the feedback of the second party. In some embodiments, such as illustrated in the user interface display 800 of FIG. 8, the user is provided an option to download or receive the document (e.g., via a clickable link) that includes the revised contract language. For example, in the documents section 802, the user is presented with options to select and receive a revised contract 804 in a selectable format (e.g., MICROSOFT WORD or ADOBE PDF). In some embodiments, the document may illustrate the changes to the contract in any known word processor format (e.g., using a “track changes” feature common to many word processing and document processing programs). In some embodiments, the guidance may further provide a draft communication to the second party specific to the feedback provided by the second party. For example, such as illustrated in the user interface display 800 FIG. 8, the user is provided an option to download or receive the document (e.g., via a clickable link) that includes the draft communication. For example, in the documents section 802, the user is presented with options to select and receive a draft Response 806 to the second party in a selectable format (e.g., MICROSOFT WORD or ADOBE PDF). The draft communication can be in any format suitable for communication to the second party (e.g., a draft email, electronic message, facsimile transmission, etc.). The draft communication includes the wording and any appropriate explanation preapproved from a legal and/or business perspective of the first party. In some embodiments, the guidance may further provide one or more draft or revised attachments to the contract specific to the feedback provided by the second party. For example, such as illustrated in the user interface display 800 FIG. 8, the user is provided an option to download or receive the document (e.g., via a clickable link) that includes the draft contract attachment. For example, in the attachments section 808, the user is presented with options to select and receive a draft attachment 810 in a selectable format (e.g., MICROSOFT WORD or ADOBE PDF). Further, any attachments needed to support the guidance and/or response options needed may be uploaded to the contract term playbook database 108, e.g., using the add attachment link 812. It is noted that the documents user interface display of FIG. 8 may be presented in response to any options entered by the user, e.g., in response to clicking “Next” in FIGS. 5-7 described herein.

In accordance with several embodiments, users of the first party are provided with prompt and consistent guidance for most feedback (pushback) situations that are likely to be encountered when negotiating contracts on behalf of the first party. The guidance is advantageously provided consistently since it is a function of the contract term playbook database and less susceptible to variations due to input from different legal professional viewpoints. Additionally, it can be appreciated that that the speed in responsiveness of the users of the first party to the second party is increased since the traditional delay with legal consultation is avoided. From the view of the first party, contracts are entered more consistently, with less time and variation and for less legal fees. Users can more confidently enter contracts and make decisions (e.g., deciding how to respond when options are presented). Adherence to use of the contract term playbook database system helps to ensure consistent responses and communications to second parties despite different second parties and different users of the first party. Users get access to approved terms and clauses without the expense of seeking legal support. The system helps ensure consistent contract responses and makes it easy for users to follow all required legal processes when negotiating contracts on behalf of the company.

As an optional next step, a user selected option responsive to the guidance is received from the user of the first party via the user interface (Step 208). In this case, the control circuit 118 receives the selected option and forwards data corresponding to this selection to the control circuit 114 of the contract database 108. The control circuit 114 then accesses the database to retrieve corresponding to retrieve additional guidance. Then, the additional guidance for response to the second party regarding the contract term is provided to the user via the user interface (Step 210). This additional guidance may be presented in any number of ways such as those described thus far or otherwise.

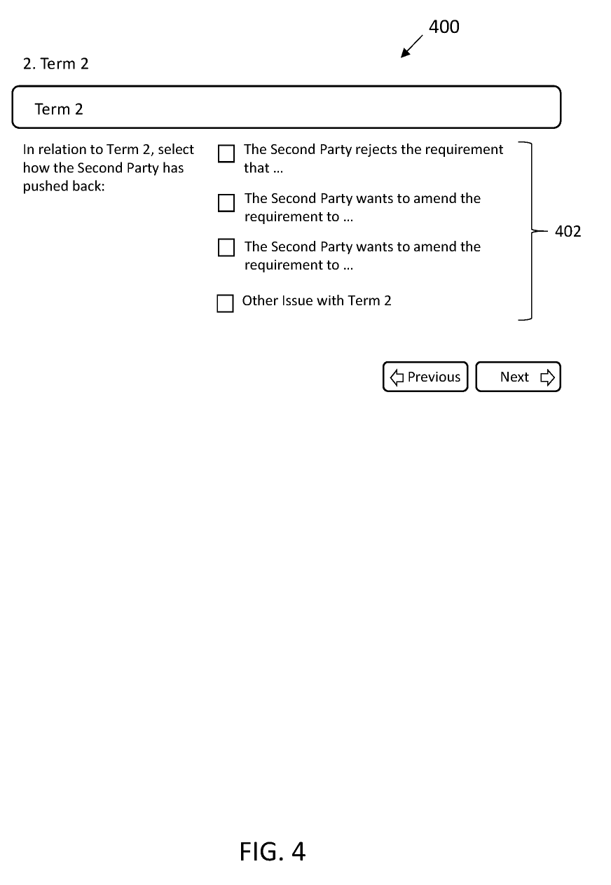

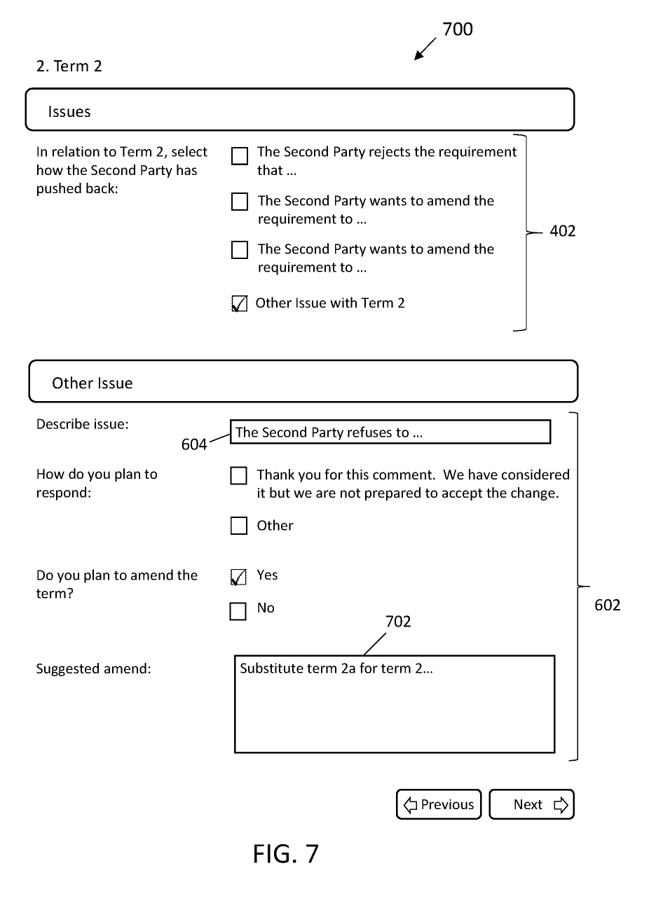

It is noted that the contract term playbook database may not always have a matching selectable second party feedback. For example, the pushback or feedback is new or a function of a different sets of facts or circumstances. In some embodiments, the user has the ability to enter this feedback and receive guidance. For example, as described above, the may select “Other issue” in the selectable list 402 of FIG. 4, and as shown in FIGS. 6 and 7, the user is presented with the option to input and describe the other feedback in the other issue input section 602 of the user interface display 600. In some embodiments, the other issue input section 602 provides a free form text entry form field 604 to allow the user to explain the second party feedback or pushback. In some embodiments, the other issue input section 602 also allows the user to input a desired response and whether or not the user plans to or would like to amend the term associated with the feedback. In this regard, should the user select that they plan to amend, as shown in the user interface display 700 of FIG. 7, a free form text entry form field 702 within the other issue input section 602 is presented that allows the user to input a desired amendment option. In such cases where the contract term playbook database 108 does not have matching guidance since the feedback does not match preapproved feedback situations, the control circuit 114 of the contract server 106 can send the appropriate notifications to the appropriate legal and/or business advisors (e.g., using the communication network 126 and/or the admin server 112) to consider this situation and provide the guidance needed by the user. In such cases, the response speed of the contract term playbook database is used for those contract terms that already have preapproved and stored guidance and specific legal/business guidance can be sought only for those issues that have not yet been fully vetted and approved.

Referring back to FIG. 2, as an optional next step, one or more of the feedback and the guidance is caused to be stored for logging (Step 212). For example, the control circuit 114 can cause the selected feedback (e.g., selected from the list 402) and/or the resulting guidance (e.g., the guidance 504 presented in guidance window 502) causes these options to be stored (e.g., in the database 108 and/or other memory, database or storage mechanism) for logging purposes. In some embodiments, the control circuit 114 outputs the appropriate signaling and commands that the database or database management tool can store the data. It is understood that number of selections and inputs by the user of the first party can be stored for logging purposes. For example, in some embodiments, one or more of information about the second party, which contract template is selected, which contract terms are selected for having feedback from the second party, which specific known feedback is selected, information about other feedback, which of response to feedback options are selected (e.g., see selectable response option list 506), which documents and/or attachments are selected, and so on can be stored for logging purposes. In some embodiments, when logging information, the control circuit 114 and/or the database 108 creates and maintains metadata relating to the transaction recording all options selected, responses provided, etc. As described further below, this metadata can be used to track over time, contractual provisions that are commonly objected to by third parties, provisions for which the company agrees to concessions, report on the frequency of when payments are varied, etc. This can allow a company to track trends and concessions in its contracting over time.

Next, as an optional next step, the contract term playbook database is updated based on one or both of the feedback and an option selected by the user in response to the guidance (Step 214). For example, this step may be performed as a part of Step 212 or as a separate step in parallel to Step 212. In some embodiments, the contract term playbook database is updated with new guidance based on the feedback not being one of the selectable known feedback options (e.g., not included in the selectable list 402, and defined through the input of “Other issues”). Once the appropriate legal and/or business professionals or representatives of the first party consider and determine an approved response to the other issue, the contract term playbook database 108 is updated. For example, in some embodiments, one or more of the selectable list 402, the guidance 504, the selectable response option list 506, the documents (FIG. 8) are updated so that future users will now have a selectable preapproved response option. In this way, the contract term playbook database and system is an iterative and adaptable system.

Next, as an optional step, reports regarding the feedback and the guidance together with additional feedback and additional guidance from negotiations with other parties regarding the contract term are generated (Step 216). In some embodiments, since much of the information entered by users about second party feedback and selected response options, etc. is stored, it is possible to run diagnostic reports spanning multiple contracts entered with multiple different second parties. For example, reports can be run to determine for one or more particular contract templates: the number of times or frequency of times that second parties provide feedback on a specific contract term, what contract terms are most frequently pushed back on by second parties, how often standard contract terms are varied, in what situations are contract terms varied, what contract terms are most frequently conceded by the first party, what contract terms are pushed back on that result in a contract not being formed, how often different response options are selected or not, and how often the consideration changes during negotiation, for example. In some embodiments, analysis of one or more reports, is used to determine one or more contracting trends in contract negotiations with other second parties. For example, these reports may be useful in understanding the contracting behavior of the first party, developing revisions to contract templates to include frequent concessions, including other provisions to protect against certain frequent contract revisions. In some embodiments, the reports may be used for user feedback and performance evaluation. For example, it can be determined if certain users concede to second parties more often than other users. The reports can also be used to determine if certain second parties on average are more or less difficult and thus more or less risky to contract with relative to other second parties. Such contracting trends are difficult to consider and identify when contracts are negotiated and formed in a traditional manner where contracting users independently consult with legal and/or business professionals regarding feedback from second parties. In some embodiments, many benefits of the contract negotiation assistance systems described herein are implemented when the first party executes many contract with many other second parties during a given period of time. However, it is understood that the systems and methods described herein may be beneficial regardless of scale in ensuring consistency in how other party feedback is handled.

It is noted that the systems and methods described herein for use in assisting users with negotiating contracts may be implemented in several models. For example, in some embodiments, a direct model is implemented where the control circuit 114, the contract server 106, the admin server 112 and the contract term playbook database 108 are controlled and maintained by the first party. For example, the first party may be a company that routinely enters multiple contracts with multiple other second parties. The system is provided to users (employees) of the first party via user interfaces 110 that communicate with the server 106 and database 108. In other embodiments, a subscription model is implemented where the control circuit 114, the contract server 106, the admin server 112 and the contract term playbook database 108 are controlled and maintained by a third party that provides a service a plurality of ‘first parties’ to assist the first parties and the plurality of first parties in contract negotiations with other second parties. For example, a given first party may be a small company or individual that does not have the contracting scale to develop such a database, but instead subscribes to a service (e.g., subscription fee, flat fee, commission, etc.) offered by the entity maintaining and controlling the contract server 106 and database 108. In this way, smaller companies that are less sophisticated to contracting have access to contract templates, and known and professionally vetted and preapproved responsive guidance when other parties they are negotiating with provide pushback or feedback to certain terms of draft contracts. In such embodiments, the respective first parties access the contract server 106 and database 108 via their user interface 110 via the communication network 126. Whether in the direct model or the subscription model, one or more of the steps of FIG. 2 may be performed. And in particular, first parties subscribing of the subscription model can benefit from the larger scale of the experiences of a larger body of contracting users. Such first parties would receive many of the same benefits as users of the direct model in that they would get prompt, consistent, low cost, preapproved response guidance and options to known feedback positions to known contract terms of template contracts, as well as draft responsive communications and/or attachments. It is understood that the contracts available for selection can range from simple contracts such as simple sales, rental agreements, etc. to complex business relationships such as development agreements, financing agreements, license agreements, etc.

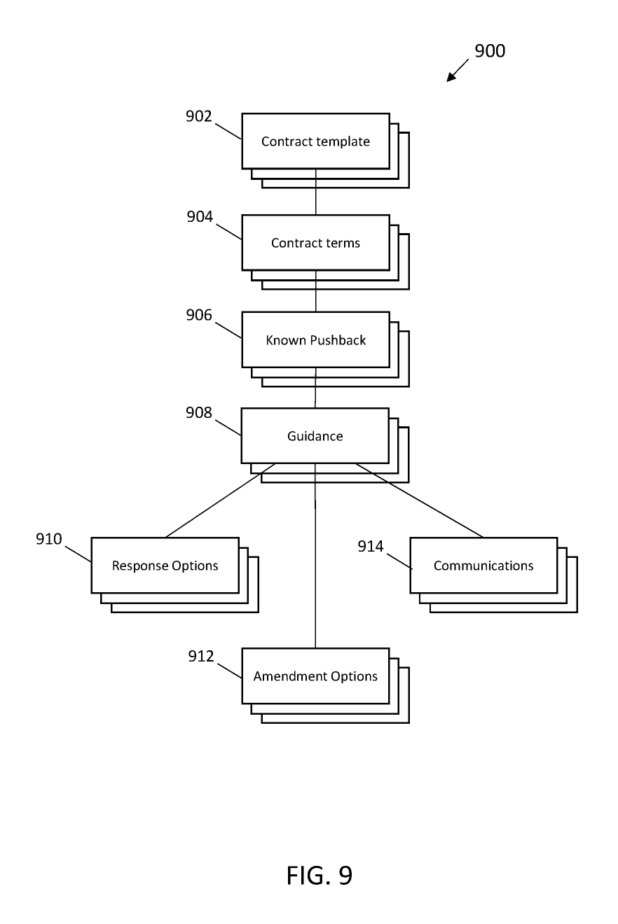

Referring next to FIG. 9, various data stored in a database structure are illustrated in accordance with some embodiments. Generally, in some embodiments, the data stored in a hierarchical database structure including a plurality of contract templates 902. For each contract template 902, a plurality of contract terms 904 is stored and associated therewith. The contract terms are specific to the contract templates, although some terms may be common to multiple templates. Additionally, in some embodiments, for each contract term 904, a plurality of known pushback positions 906 is stored and associated therewith. That is, the pushback positions are the possible known feedback that may be provided by a second party responsive to being presented with the given contract term. In some embodiments, for each known pushback position 906, one or more sets of guidance 908 is stored and associated therewith. The guidance 908 may be any of the guidance as described herein. In some embodiments, for each set of guidance 908, one or more response options 910 is stored and associated therewith. In some embodiments, for each set of guidance 908, one or more amendment options 912 (e.g., draft contract revisions, and/or attachments) is also stored and associated therewith. And in some embodiments, for each set of guidance 908, one or more draft communications 914 is stored and associated therewith. The guidance 908, response options 910, amendment options 912 and communications 914 may be any of those described herein and the like. It is understood that the database can be one or more general purpose or specific purposes databases implemented on one or more computer based or memory based devices and having data stored in any known structures or formats and may be managed by one or more database management systems. The contract term playbook database may be any navigational, relational or post-relational database or other database model or structure.

In some embodiments, systems, apparatuses, methods, and processes are provided to assist parties in contract negotiations. In some embodiments, a system for use by a first party in contract negotiation with a second party comprises: a control circuit; and a contract term playbook database accessible by the control circuit; wherein the control circuit is configured to: receive, from a user of the first party via a user interface, feedback from the second party regarding a contract term of a draft contract; access the contract term playbook database using the feedback; and output, to the user via the user interface, guidance for response to the second party regarding the contract term and preapproved by the first party.

In some embodiments, a method for use by a first party in contract negotiation with a second party comprises: receiving, at a control circuit from a user of the first party via a user interface, feedback from a second party regarding a contract term of a draft contract; accessing, by the control circuit, a contract term playbook database in communication with the control circuit using the feedback; and outputting, to the user via the user interface, guidance for response to the second party regarding the contract term and preapproved by the first party

In some embodiments, a system for use by a first party in contract negotiation with a second party comprises: a control circuit; and a contract term playbook database accessible by the control circuit; wherein the control circuit is configured to: receive, from a user of the first party via a user interface, feedback from the second party regarding a contract term of a draft contract, wherein the contract term comprises a position of the first party stated in the draft contract; wherein the feedback indicates less than acceptance of the contract term by the second party, the feedback comprising one or more of a rejection of the contract term, a proposed alteration of the contract term, a proposed alternative to the contract term; access the contract term playbook database using the feedback, wherein the contract term playbook database stores data corresponding to one or more of: a plurality of contracts, a plurality of contract terms, a plurality of possible objections by opposing contracting parties to contract terms, a plurality of response options preapproved by the first party, a plurality of responsive contract term language alterations preapproved by the first party, a plurality of complete contracts including responsive contract term language alterations preapproved by the first party, and a plurality of draft responsive communications to opposing parties preapproved by the first party; output, to the user via the user interface, guidance for response to the second party regarding the contract term and preapproved by the first party, wherein the guidance comprises one or more of: a response option preapproved by the first party, a set of response options preapproved by the first party, a responsive contract term language alteration preapproved by the first party, a complete contract including the responsive contract term language alteration preapproved by the first party, and a draft responsive communication to the second party preapproved by the first party, wherein the response option comprises one or more of: a rejection of the feedback, an acceptance of the feedback, a contract term alteration preapproved by the first party, and a proposed alternative to the contract term preapproved by the first party; and cause one or more of the feedback and the guidance to be stored for logging.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for use by a first party in contract negotiation with a second party, the system comprising:
a control circuit; and
a contract term playbook database accessible by the control circuit;
wherein the control circuit is configured to:
receive, from a user of the first party via a user interface, feedback from the second party regarding a contract term of a draft contract;
access the contract term playbook database using the feedback; and
output, to the user via the user interface, guidance for response to the second party regarding the contract term and preapproved by the first party.

2. The system of claim 1 wherein the contract term comprises a position of the first party stated in the draft contract.

3. The system of claim 1 wherein the feedback indicates less than acceptance of the contract term by the second party, the feedback comprising one or more of a rejection of the contract term, a proposed alteration of the contract term, a proposed alternative to the contract term.

4. The system of claim 1 wherein the contract term playbook database stores data corresponding to one or more of: a plurality of contracts, a plurality of contract terms, a plurality of possible objections by opposing contracting parties to contract terms, a plurality of response options preapproved by the first party, a plurality of responsive contract term language alterations preapproved by the first party, a plurality of complete contracts including responsive contract term language alterations preapproved by the first party, and a plurality of draft responsive communications to opposing parties preapproved by the first party.

5. The system of claim 1 wherein the control circuit is configured to access the contract term playbook database to match the feedback to the guidance.

6. The system of claim 1 wherein the guidance comprises one or more of: a response option preapproved by the first party, a set of response options preapproved by the first party, a responsive contract term language alteration preapproved by the first party, a complete contract including the responsive contract term language alteration preapproved by the first party, and a draft responsive communication to the second party preapproved by the first party.

7. The system of claim 6 wherein the response option comprises one or more of: a rejection of the feedback, an acceptance of the feedback, a contract term alteration preapproved by the first party, and a proposed alternative to the contract term preapproved by the first party.

8. The system of claim 1 wherein the control circuit is further configured to:
receive, from the user of the first party via the user interface, a user selected option responsive to the guidance; and
provide, to the user via the user interface, additional guidance for response to the second party regarding the contract term.

9. The system of claim 1 wherein control circuit is further configured to cause one or more of the feedback and the guidance to be stored for logging.

10. The system of claim 9 wherein control circuit is further configured to generate reports regarding the feedback and the guidance together with additional feedback and additional guidance from negotiations with other parties regarding the contract term.

11. The system of claim 1 wherein the control circuit is configured to update the contract term playbook database based on one or both of the feedback and an option selected by the user in response to the guidance.

12. The system of claim 1 wherein the control circuit is controlled and maintained by one of:
the first party; and
a third party providing a service subscribed to by a plurality of parties including the first party to assist the first party and the plurality of parties in contract negotiations.

13. A method for use by a first party in contract negotiation with a second party, the method comprising:
receiving, at a control circuit from a user of the first party via a user interface, feedback from a second party regarding a contract term of a draft contract;
accessing, by the control circuit, a contract term playbook database in communication with the control circuit using the feedback; and
outputting, to the user via the user interface, guidance for response to the second party regarding the contract term and preapproved by the first party.

14. The method of claim 13 wherein the guidance comprises one or more of: a response option preapproved by the first party, a set of response options preapproved by the first party, a responsive contract term language alteration preapproved by the first party, a complete contract including the responsive contract term language alteration preapproved by the first party, and a draft responsive communication to the second party preapproved by the first party.

15. The method of claim 14 wherein the response option comprises one or more of: a rejection of the feedback, an acceptance of the feedback, a contract term alteration preapproved by the first party, and a proposed alternative to the contract term preapproved by the first party.

16. The method of claim 13 further comprising causing, by the control circuit, one or more of the feedback and the guidance to be stored for logging.

17. The method of claim 16 further comprising generating, by the control circuit, reports regarding the feedback and the guidance together with additional feedback and additional guidance from negotiations with other parties regarding the contract term.

18. The method of claim 13 further comprising updating, by the control circuit, the contract term playbook database based on one or both of the feedback and an option selected by the user in response to the guidance.

19. The method of claim 13 wherein the control circuit is controlled and maintained by one of:
the first party; and
a third party providing a service subscribed to by a plurality of parties including the first party to assist the first party and the plurality of parties in contract negotiations.

20. A system for use by a first party in contract negotiation with a second party, the system comprising:
a control circuit; and
a contract term playbook database accessible by the control circuit;
wherein the control circuit is configured to:
receive, from a user of the first party via a user interface, feedback from the second party regarding a contract term of a draft contract, wherein the contract term comprises a position of the first party stated in the draft contract; wherein the feedback indicates less than acceptance of the contract term by the second party, the feedback comprising one or more of a rejection of the contract term, a proposed alteration of the contract term, a proposed alternative to the contract term;
access the contract term playbook database using the feedback, wherein the contract term playbook database stores data corresponding to one or more of: a plurality of contracts, a plurality of contract terms, a plurality of possible objections by opposing contracting parties to contract terms, a plurality of response options preapproved by the first party, a plurality of responsive contract term language alterations preapproved by the first party, a plurality of complete contracts including responsive contract term language alterations preapproved by the first party, and a plurality of draft responsive communications to opposing parties preapproved by the first party;
output, to the user via the user interface, guidance for response to the second party regarding the contract term and preapproved by the first party, wherein the guidance comprises one or more of: a response option preapproved by the first party, a set of response options preapproved by the first party, a responsive contract term language alteration preapproved by the first party, a complete contract including the responsive contract term language alteration preapproved by the first party, and a draft responsive communication to the second party preapproved by the first party, wherein the response option comprises one or more of: a rejection of the feedback, an acceptance of the feedback, a contract term alteration preapproved by the first party, and a proposed alternative to the contract term preapproved by the first party; and
cause one or more of the feedback and the guidance to be stored for logging.
